(19) United States
(12) Patent Application Publication
(10) Pub. No.: US 2015/0317143 A1
(43) Pub. Date: Nov. 5, 2015

(54) METHOD AND APPARATUS FOR INSTALLING WEBPAGE APPLICATION

(71) Applicant: Tencent Technology (Shenzhen) Company Limited, Shenzhen (CN)

(72) Inventor: Jiangquan HUANG, Shenzhen (CN)

(21) Appl. No.: 14/752,679

(22) Filed: Jun. 26, 2015

Related U.S. Application Data
(63) Continuation of application No. PCT/CN2013/088836, filed on Dec. 9, 2013.

(30) Foreign Application Priority Data
Dec. 27, 2012 (CN) 201210580501.2

(51) Int. Cl. G06F 9/445; G06F 3/0481

(52) U.S. Cl. CPC G06F 8/61; G06F 3/04817

(57) ABSTRACT

The present disclosure discloses a method and apparatus for installing a webpage application. The method is implemented as follows. If a webpage opened by a browser includes a preset language code, the browser sends a request message to a browser server through a local interface. The request message contains an address of the opened webpage and is configured to request the browser server to send a data packet of a webpage application corresponding to the address of the opened webpage. The browser receives the data packet of the webpage application from the browser server. The data packet of the webpage application contains a name, website and identification code of the webpage application. The browser displays, on the opened webpage, information of installing the webpage application. The information is configured to prompt a user to install the webpage application on the home page of the browser.

### CROSS-REFERENCE TO RELATED APPLICATIONS

This application is a continuation of International Application No. PCT/CN2013/088836, filed on Dec. 9, 2013, which claims the benefit and priority of Chinese Patent Application No. 201210580501.2, filed Dec. 27, 2012. The entire disclosures of each of the above applications are incorporated herein by reference.

### TECHNICAL FIELD

The present disclosure relates to communication technologies, and more particularly to a method and apparatus for installing a webpage application.

### BACKGROUND

Many webpage applications applicable to mobile terminal devices have been developed. For example, these webpage application may include a 2-dimensional bar code application, a Tencent micro-blog application, a Qzone application, a my bookshelf application, and a webpage application provided to a user by an operator. The user may install needed webpage applications on a home page of a browser of a mobile terminal device.

At present, the user needs to first select a webpage application from various webpage applications opened by the user, and then manually install the selected webpage application on the home page of the browser. However, this method for installing a webpage application has a low efficiency and is inconvenient for the user.

### SUMMARY OF THE INVENTION

Examples of the present disclosure provide a method and apparatus for installing a webpage application. By the method and apparatus, the webpage application may be automatically recognized and installed on a home page of a browser of a mobile terminal device.

The method for installing a webpage application includes:

if a webpage opened by a browser includes a preset language code, sending, by the browser, a request message to a browser server through a local interface, wherein the request message contains an address of the opened webpage and is configured to request the browser server to send a data packet of a webpage application corresponding to the address of the opened webpage;

receiving, by the browser, the data packet of the webpage application from the browser server, wherein the data packet of the webpage application contains a name, website and identification code of the webpage application; and

displaying, by the browser on the opened webpage, information of installing the webpage application, wherein the information is configured to prompt a user to install the webpage application on the home page of the browser.

The apparatus for installing a webpage application includes:

a sending unit, configured to, if a webpage opened by a browser includes a preset language code, send a request message to a browser server through a local interface of the browser, wherein the request message contains an address of the opened webpage and is configured to request the browser server to send a data packet of a webpage application corresponding to the address of the opened webpage;

a receiving unit, configured to receive the data packet of the webpage application from the browser server, wherein the data packet of the webpage application contains a name, website and identification code of the webpage application; and

a displaying unit, configured to display, on the opened webpage, information of installing the webpage application, wherein the information is configured to prompt a user to install the webpage application on the home page of the browser.

By the above method and apparatus, the webpage application may be automatically recognized and installed, thereby improving the installing efficiency of the webpage application and the experiences of the user.

### BRIEF DESCRIPTION OF DRAWINGS

The accompanying drawings referred to in the examples are illustrated briefly hereinafter. Obviously, these accompanying drawings are some examples of the present disclosure, and according to these accompanying drawings, those skilled in the art can obtain other accompanying drawings without creative labor.

FIG. 1 is a schematic flowchart illustrating a method for installing a webpage application according to an example of the present disclosure.

FIG. 2 is a schematic flowchart illustrating a method for installing a webpage application according to another example of the present disclosure.

FIG. 3 is a schematic diagram illustrating the structure of an apparatus for installing a webpage application according to an example of the present disclosure.

FIG. 4 is a schematic diagram illustrating the structure of an apparatus for installing a webpage application according to another example of the present disclosure.

FIG. 5 is a schematic diagram illustrating the structure of an apparatus for installing a webpage application according to another example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

The solution of the present disclosure is illustrated hereinafter with reference to the accompanying drawings and examples. Obviously, the described examples are only partial examples of the present disclosure, but are not all examples. The present disclosure may be represented as different forms, and thus is not limited to the described examples. According to the examples of the present disclosure, those skilled in the art can obtain other examples without creative labor, which belong to the protection scope of the present disclosure.

The examples of the present disclosure provide a method and apparatus for installing a webpage application. By the method and apparatus, a browser of a mobile terminal device may automatically recognize and install the webpage application when opening a webpage.

In an example, a webpage application that may be automatically recognized and installed on the home page of the browser needs to register an address of the webpage application on a browser server run at the background of the browser of the mobile terminal device. In this example, the address of the webpage application may be a Uniform/Universal Resource Locator (URL).

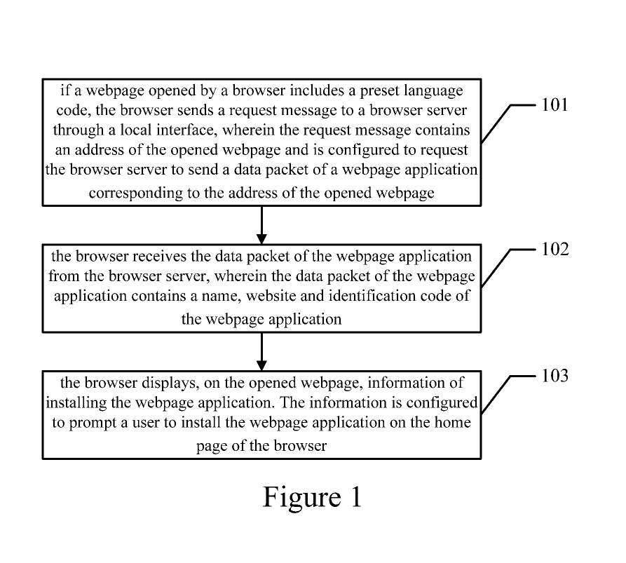

FIG. 1 is a schematic flowchart illustrating a method for installing a webpage application according to an example of the present disclosure. As shown in FIG. 1, the method includes following blocks.

At block 101, if a webpage opened by a browser includes a preset language code, the browser sends a request message to a browser server through a local interface, wherein the request message contains an address of the opened webpage and is configured to request the browser server to send a data packet of a webpage application corresponding to the address of the opened webpage.

In this example, the webpage opened by the browser is a webpage application. The language code is preset in the webpage and is configured to call the local interface of the browser to send the request message to the browser server.

If the webpage opened by the browser includes the preset language code, the browser sends the request message to the browser server. The request message contains a URL of the opened webpage and is configured to request the browser server to send the data packet of the webpage application corresponding to the URL of the opened webpage.

The URL of the webpage opened by the browser is the same as a URL of the webpage application requested by the browser. According to the URL of the webpage opened by the browser, the browser server may determine whether the webpage application has been registered on the browser server.

At block 102, the browser receives the data packet of the webpage application from the browser server, wherein the data packet of the webpage application contains a name, website and identification code of the webpage application. The browser sends the request message containing the URL of the opened webpage to the browser server through the local interface. After receiving the request message, the browser server searches a database to determine whether the webpage application has been registered. If the browser server determines that the webpage application has been registered, the browser server sends the data packet of the webpage application to the browser. The browser receives the data packet of the webpage application from the browser server. The data packet of the webpage application contains the name, URL and identification code of the webpage application. The identification code may be denoted with a field “app id”. The identification code corresponds to the webpage application uniquely. Even if the name of the webpage application is changed, the identification code may still identify the webpage application uniquely.

At block 103, the browser displays, on the opened webpage, information of installing the webpage application. The information is configured to prompt a user to install the webpage application on the home page of the browser.

After receiving the data packet of the webpage application from the browser server, the browser may determine that the opened webpage is a valid webpage application. The browser displays the information of installing the webpage application according to the name, URL and identification code of the webpage application contained in the data packet of the webpage application. The information of installing the webpage application may prompt the user to install the webpage application on the home page of the browser.

By the method provided according to the example of the present disclosure, the webpage application may be automatically recognized and installed, thereby improving the installing efficiency of the webpage application and the experiences of the user.

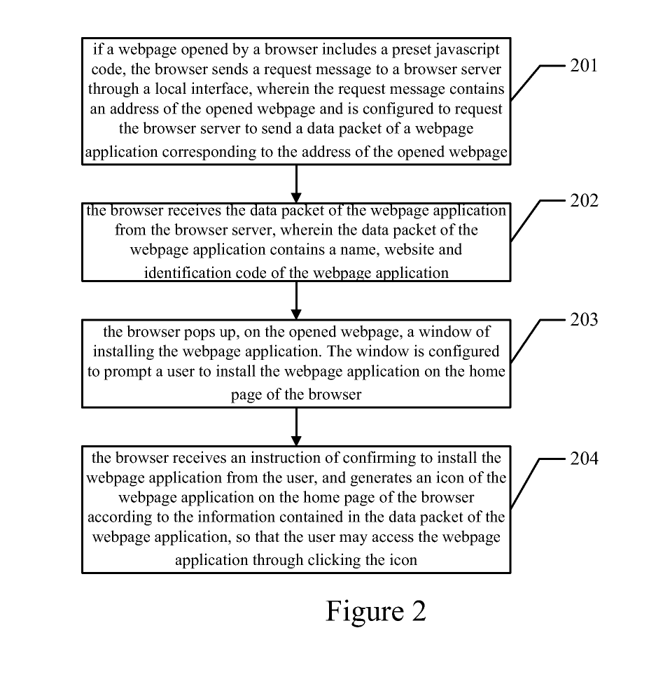

FIG. 2 is a schematic flowchart illustrating a method for installing a webpage application according to another example of the present disclosure. As shown in FIG. 2, the method includes following blocks.

At block 201, if a webpage opened by a browser includes a preset javascript code, the browser sends a request message to a browser server through a local interface, wherein the request message contains an address of the opened webpage and is configured to request the browser server to send a data packet of a webpage application corresponding to the address of the opened webpage.

In this example, the webpage opened by the browser is a webpage application. A javascript code is preset in the webpage and is configured to call the local interface of the browser to send the request message to the browser server.

If the webpage opened by the browser includes the preset javascript code, the browser sends the request message to the browser server. The request message contains a URL of the opened webpage and is configured to request the browser server to send the data packet of the webpage application corresponding to the URL of the opened webpage.

The URL of the webpage opened by the browser is the same as a URL of the webpage application requested by the browser. According to the URL of the webpage opened by the browser, the browser server may determine whether the webpage application has been registered on the browser server.

At block 202, the browser receives the data packet of the webpage application from the browser server, wherein the data packet of the webpage application contains a name, website and identification code of the webpage application.

The browser sends the request message containing the URL of the opened webpage to the browser server through the local interface. After receiving the request message, the browser server searches a database to determine whether the webpage application has been registered. If the browser server determines that the webpage application has been registered, the browser server sends the data packet of the webpage application to the browser. The browser receives the data packet of the webpage application from the browser server. The data packet of the webpage application contains the name, URL and identification code of the webpage application. The identification code may be denoted with a field “app id”. The identification code corresponds to the webpage application uniquely. Even if the name of the webpage application is changed, the identification code may still identify the webpage application uniquely.

At block 203, the browser pops up, on the opened webpage, a window of installing the webpage application. The window is configured to prompt a user to install the webpage application on the home page of the browser. After receiving the data packet of the webpage application from the browser server, the browser may determine that the opened webpage is a valid webpage application. The browser pops up the window of installing the webpage application according to the name, URL and identification code of the webpage application contained in the data packet of the webpage application. The window of installing the webpage application may prompt the user to install the webpage application on the home page of the browser.

At block 204, the browser receives an instruction of confirming to install the webpage application from the user, and generates an icon of the webpage application on the home page of the browser according to the information contained in the data packet of the webpage application, so that the user may access the webpage application through clicking the icon.

In an example, the information contained in the data packet may be name information, icon information and URL information of the webpage application. After the icon is generated by the browser, the user may access the webpage application through clicking the icon without needing to input the URL of the webpage application, thereby simplifying the operations of the user.

By the method provided according to the example of the present disclosure, the webpage application may be automatically recognized and installed, thereby improving the installing efficiency of the webpage application and the experiences of the user.

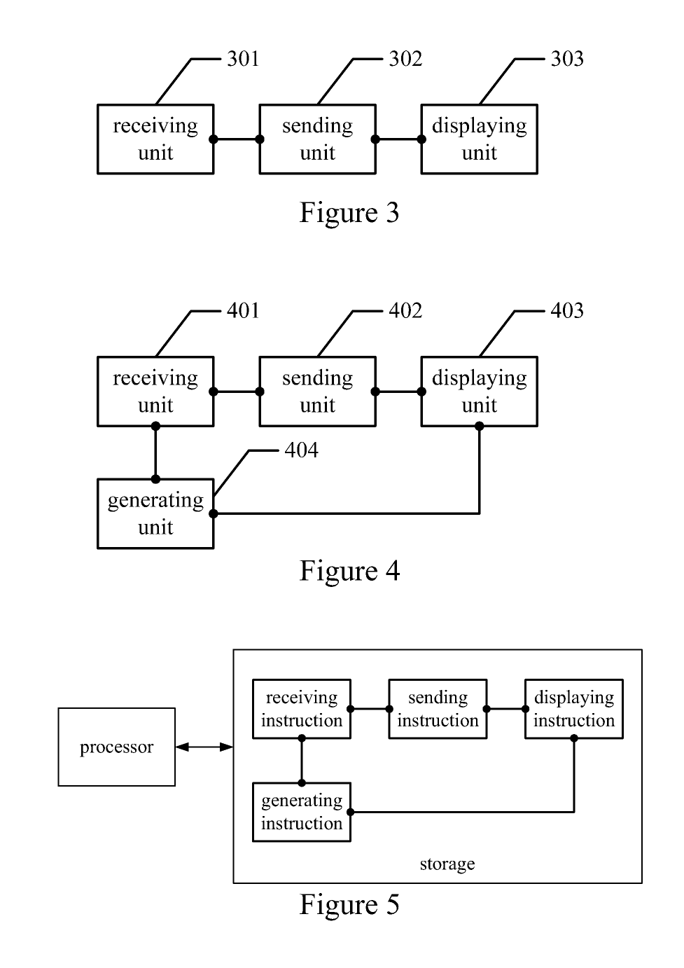

FIG. 3 is a schematic diagram illustrating the structure of an apparatus for installing a webpage application according to an example of the present disclosure. As shown in FIG. 3, the apparatus includes a sending unit 301, a receiving unit 302 and a displaying unit 303.

If a webpage opened by a browser includes a preset language code, the sending unit 301 sends a request message to a browser server through a local interface of the browser. The request message contains an address of the opened webpage and is configured to request the browser server to send a data packet of a webpage application corresponding to the address of the opened webpage.

In this example, the address of the webpage application may be a Uniform/Universal Resource Locator (URL)

In this example, the webpage opened by the browser is a webpage application. The language code is preset in the webpage and is configured to call the local interface of the browser to send the request message to the browser server.

The URL of the webpage opened by the browser is the same as a URL of the webpage application requested by the sending unit 301. According to the URL of the webpage opened by the browser, the browser server may determine whether the webpage application has been registered on the browser server.

The receiving unit 302 receives the data packet of the webpage application from the browser server, wherein the data packet of the webpage application contains a name, website and identification code of the webpage application.

After receiving the request message, the browser server searches a database to determine whether the webpage application has been registered. If the browser server determines that the webpage application has been registered, the browser server sends the data packet of the webpage application to the receiving unit 302. The receiving unit 302 receives the data packet of the webpage application from the browser server. The data packet of the webpage application contains the name, URL and identification code of the webpage application. The identification code may be denoted with a field “app id”. The identification code corresponds to the webpage application uniquely. Even if the name of the webpage application is changed, the identification code may still identify the webpage application uniquely.

The displaying unit 303 displays, on the opened webpage, information of installing the webpage application. The information is configured to prompt a user to install the webpage application on the home page of the browser.

After the receiving unit 302 receives the data packet of the webpage application from the browser server, the receiving unit 302 may determine that the opened webpage is a valid webpage application. The displaying unit 303 displays the information of installing the webpage application according to the name, URL and identification code of the webpage application contained in the data packet of the webpage application. The information of installing the webpage application may prompt the user to install the webpage application on the home page of the browser.

By the apparatus provided according to the example of the present disclosure, the webpage application may be automatically recognized and installed, thereby improving the installing efficiency of the webpage application and the experiences of the user.

FIG. 4 is a schematic diagram illustrating the structure of an apparatus for installing a webpage application according to another example of the present disclosure.

As shown in FIG. 4, the apparatus includes a sending unit 401, a receiving unit 402 and a displaying unit 403.

If a webpage opened by a browser includes a preset language code, the sending unit 401 sends a request message to a browser server through a local interface of the browser. The request message contains an address of the opened webpage and is configured to request a browser server to send a data packet of a webpage application corresponding to the address of the opened webpage.

The receiving unit 402 receives the data packet of the webpage application from the browser server, wherein the data packet of the webpage application contains a name, website and identification code of the webpage application.

The displaying unit 303 displays, on the opened webpage, information of installing the webpage application. The information is configured to prompt a user to install the webpage application on the home page of the browser.

The receiving unit 402 may further receive an instruction of confirming to install the webpage application from the user.

In an example, the apparatus further includes a generating unit 404.

The generating unit 404 may generate an icon of the webpage application on the home page of the browser according to the name, website and identification code of the webpage application contained in the data packet of the webpage application, so that the user may access the webpage application through clicking the icon.

The displaying unit 403 may pop up, on the opened webpage, a window of installing the webpage application. The window is configured to prompt the user to install the webpage application on the home page of the browser.

In an implementation, the preset language code may be a preset javascript code. The preset javascript code is configured to call the local interface of the browser to send the request message to the browser server.

The units of the apparatus provided according to the above example may implement the processes of the methods shown in FIGS. 1 and 2, and are not illustrated herein.

By the apparatus provided according to the example of the present disclosure, the webpage application may be automatically recognized and installed, thereby improving the installing efficiency of the webpage application and the experiences of the user.

FIG. 5 is a schematic diagram illustrating the structure of an apparatus for installing a webpage application according to another example of the present disclosure. As shown in FIG. 5, the apparatus for installing a webpage application at least includes a storage and a processor communicating with the storage, in which the storage includes a sending instruction, a receiving instruction and a displaying instruction that can be executed by the processor. The storage may be a non-transitory computer readable storage medium and the sending instruction, the receiving instruction and the displaying instruction may be machine readable instructions stored in the storage. The processor may also execute the machine readable instructions stored in the storage.

The sending instruction is configured to, if a webpage opened by a browser includes a preset language code, send a request message to a browser server through a local interface of the browser, wherein the request message contains an address of the opened webpage and is configured to request the browser server to send a data packet of a webpage application corresponding to the address of the opened webpage.

The receiving instruction is configured to receive the data packet of the webpage application from the browser server, wherein the data packet of the webpage application contains a name, website and identification code of the webpage application.

The displaying instruction is configured to display, on the opened webpage, information of installing the webpage application, wherein the information is configured to prompt a user to install the webpage application on the home page of the browser.

In an implementation, the receiving instruction is further configured to receive an instruction of confirming to install the webpage application from the user.

In an implementation, the apparatus further includes:

a generating instruction, configured to generate an icon of the webpage application on the home page of the browser according to the name, website and identification code of the webpage application contained in the data packet of the webpage application, so that the user accesses the webpage application through clicking the icon.

In an implementation, the displaying instruction is configured to pop up, on the opened webpage, a window of installing the webpage application.

In an implementation, the preset language code is a preset javascript code, and the preset javascript code is configured to call the local interface of the browser to send the request message to the browser server.

Those skilled in the art can understand that all or part of steps in the method provided by the examples of the present disclosure may be implemented by instructing related hardware by a program, the program may be stored in a readable memory of a computer, and above method steps are included when the program is operated. The memory includes a ROM/RAM, a disk, a Compact Disc (CD) and so on.

Accordingly, an example of the present disclosure provides a non-transitory computer readable medium, which includes computer program codes for executing the processes of the method illustrated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for installing a webpage application, comprising:
if a webpage opened by a browser includes a preset language code, sending, by the browser, a request message to a browser server through a local interface, wherein the request message contains an address of the opened webpage and is configured to request the browser server to send a data packet of a webpage application corresponding to the address of the opened webpage;
receiving, by the browser, the data packet of the webpage application from the browser server, wherein the data packet of the webpage application contains a name, website and identification code of the webpage application; and
displaying, by the browser on the opened webpage, information of installing the webpage application, wherein the information is configured to prompt a user to install the webpage application on the home page of the browser.

2. The method of claim 1, after displaying, on the opened webpage, the information of installing the webpage application, further comprising:
receiving an instruction of confirming to install the webpage application from the user.

3. The method of claim 1, further comprising:
generating an icon of the webpage application on the home page of the browser according to the name, website and identification code of the webpage application contained in the data packet of the webpage application, so that the user accesses the webpage application through clicking the icon.

4. The method of claim 2, further comprising:
generating an icon of the webpage application on the home page of the browser according to the name, website and identification code of the webpage application contained in the data packet of the webpage application, so that the user accesses the webpage application through clicking the icon.

5. The method of claim 3, wherein the displaying, on the opened webpage, the information of installing the webpage application comprises:
popping up, on the opened webpage, a window of installing the webpage application.

6. The method of claim 4, wherein the displaying, on the opened webpage, the information of installing the webpage application comprises:
popping up, on the opened webpage, a window of installing the webpage application.

7. The method of claim 1, wherein the preset language code is a preset javascript code, and the preset javascript code is configured to call the local interface of the browser to send the request message to the browser server.

8. An apparatus for installing a webpage application, comprising:
a sending unit, configured to, if a webpage opened by a browser includes a preset language code, send a request message to a browser server through a local interface of the browser, wherein the request message contains an address of the opened webpage and is configured to request the browser server to send a data packet of a webpage application corresponding to the address of the opened webpage;
a receiving unit, configured to receive the data packet of the webpage application from the browser server, wherein the data packet of the webpage application contains a name, website and identification code of the webpage application; and
a displaying unit, configured to display, on the opened webpage, information of installing the webpage application, wherein the information is configured to prompt a user to install the webpage application on the home page of the browser.

9. The apparatus of claim 8, wherein the receiving unit is further configured to receive an instruction of confirming to install the webpage application from the user.

10. The apparatus of claim 8, further comprising:
a generating unit, configured to generate an icon of the webpage application on the home page of the browser according to the name, website and identification code of the webpage application contained in the data packet of the webpage application, so that the user accesses the webpage application through clicking the icon.

11. The apparatus of claim 9, further comprising:
a generating unit, configured to generate an icon of the webpage application on the home page of the browser according to the name, website and identification code of the webpage application contained in the data packet of the webpage application, so that the user accesses the webpage application through clicking the icon.

12. The apparatus of claim 10, wherein the displaying unit is configured to pop up, on the opened webpage, a window of installing the webpage application.

13. The apparatus of claim 11, wherein the displaying unit is configured to pop up, on the opened webpage, a window of installing the webpage application.

14. The apparatus of claim 8, wherein the preset language code is a preset javascript code, and the preset javascript code is configured to call the local interface of the browser to send the request message to the browser server.

15. A non-transitory computer readable medium, comprising computer program codes for executing following steps:
if a webpage opened by a browser includes a preset language code, sending, by the browser, a request message to a browser server through a local interface, wherein the request message contains an address of the opened webpage and is configured to request the browser server to send a data packet of a webpage application corresponding to the address of the opened webpage;
receiving, by the browser, the data packet of the webpage application from the browser server, wherein the data packet of the webpage application contains a name, website and identification code of the webpage application; and
displaying, by the browser on the opened webpage, information of installing the webpage application, wherein the information is configured to prompt a user to install the webpage application on the home page of the browser.
